(19) United States
(12) Patent Application Publication
(10) Pub. No.: US 2026/0323516 A1
(43) Pub. Date: Oct. 15, 2026

(54) NFC DEVICE

(71) Applicant: STMICROELECTRONICS INTERNATIONAL N.V., Geneva (CH)

(72) Inventors: Sylvain ENGELS, Meylan (FR); Andrei BANCIU, Gieres (FR)

(21) Appl. No.: 19/630,690

(22) Filed: Mar. 27, 2026

(30) Foreign Application Priority Data
Apr. 11, 2025 (FR) 2503873

(51) Int. Cl. H04W 52/02; H04W 52/56

(52) U.S. Cl. CPC H04W 52/0225; H04W 52/56

(57) ABSTRACT

The present disclosure provides a type-A NFC device. An example type-A NFC device includes a type-A frame demodulator configured to cause a waking up of a control unit when at least one start of frame is detected as not being of type A.

### CROSS REFERENCE TO RELATED APPLICATIONS

This application claims the priority benefit of French Patent Application Number FR2503873, filed on Apr. 11, 2025, entitled "DISPOSITIF NFC", which is hereby incorporated by reference to the maximum extent allowable by law.

### Technical Field

The present disclosure generally concerns NFC devices and their operating methods.

### Bacground

Some NFC devices operate according to technology types called type A or type B, as described in ISO standard 14443-3 or according to the NFC Forum. NFC devices, according to their specification, need to be able to work with one or the other or even both technologies.

### BRIEF SUMMARY

In the case of NFC devices only compatible with the type-A (respectively B) technology, there exists a need to be protected against the processing of frames that may resemble type-A (respectively B) frames but which are not, which may result in a malfunction of the NFC device.

In the case of NFC devices compatible with type-A and B technologies, there exists a need for NFC devices to be capable of robustly telling whether the received frames belong to a type A or to a type B.

An embodiment overcomes all or part of the disadvantages of known NFC devices.

An embodiment provides a type-A NFC device comprising a type-A frame demodulator configured to cause the waking up of a control unit when at least one start of frame is detected as not being of type A.

An embodiment provides a method of operation of a type-A NFC device comprising a type-A frame demodulator; the method comprising the waking up, by the demodulator, of a control unit when at least one start of frame is detected as not being of type A.

According to an embodiment, to cause the waking up of the control unit, the demodulator modifies a state of a first signal.

According to an embodiment, the first signal is applied to an error output.

According to an embodiment, the error output is an error output of a cyclic redundancy code.

According to an embodiment, the error output is an error output of an error correction code.

According to an embodiment, the demodulator is configured to reject, or not process, the frame having had its start of frame detected as not being of type A.

According to an embodiment, an interrupt is generated after the waking up of the control unit.

According to an embodiment, after the interrupt, the control unit analyzes the content of the frame having had its start of frame detected as not being of type A and performs an action.

According to an embodiment, the demodulator is configured to analyze at least two consecutive symbols to detect that a start-of-frame symbol is not of type A.

According to an embodiment, the demodulator is configured to determine a first start-of-frame time period elapsing between a first falling edge arriving first and a first rising edge arriving after the first falling edge.

According to an embodiment, the demodulator is configured to determine a second start-of-frame time period elapsing between the first rising edge arriving after the first falling edge, and a second falling edge arriving after the first rising edge.

According to an embodiment, the first time period corresponds to a first modulated portion and the second falling edge corresponds to the start of a second modulated portion arriving second after the first modulated portion.

According to an embodiment, the demodulator is configured to verify the following conditions according to which:
the first time period lies within a first time interval; and
the second time period lies within a second time interval;

if one of these conditions is not met, then the start of frame is considered as not being of type A.

According to an embodiment, the first and second time intervals are determined from start-of-frame characteristics defined in ISO standard 14443 or the NFC forum, to which respective time values are added or subtracted.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows a system comprising an NFC device to which the described embodiments can be applied;

FIG. 2 shows a timing diagram of an example of operation of an NFC device of FIG. 1;

FIG. 3 shows a timing diagram of an example of operation of an NFC device of FIG. 1;

FIG. 4 shows a timing diagram of operation of an NFC device of FIG. 1;

FIG. 5 shows a method of operation of an NFC device of FIG. 1 according to an embodiment of a first aspect;

FIG. 6 shows an embodiment of a step of the method of FIG. 5;

FIG. 7 shows a method of operation of an NFC device of FIG. 1 according to a second aspect; and

FIG. 8 shows an embodiment of a step of the method of FIG. 7.

### DETAILED DESCRIPTION

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

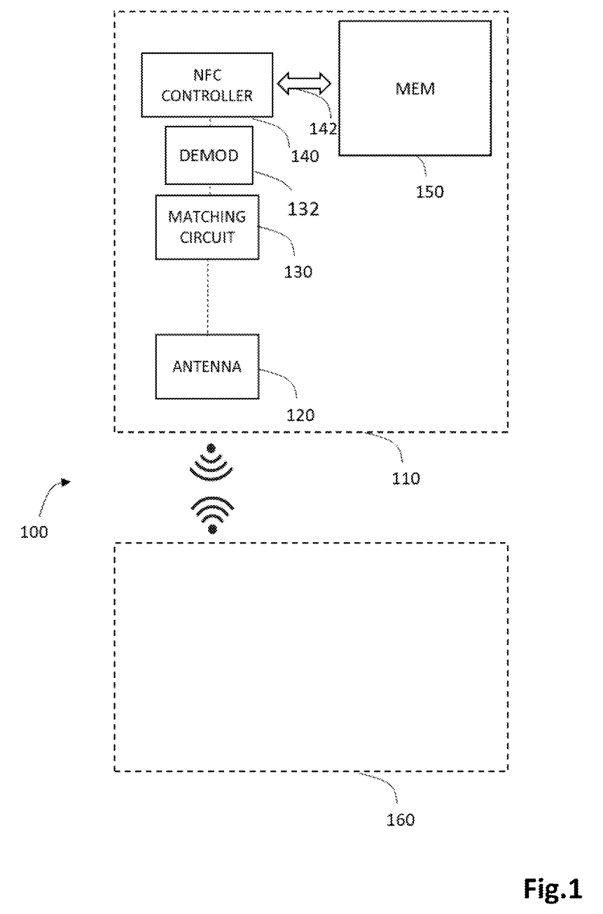

FIG. 1 shows a system 100 comprising an NFC device 110, 160 to which the described embodiments can be applied.

System 100 comprises a first NFC device 110 that can communicate with a second NFC device 160. This NFC (Near Field Communication) technology concerns the establishing of communications at very short distance (generally shorter than ten centimeters) between these two devices 110, 160.

NFC systems or, in other words, near-field communication systems use a radio frequency electromagnetic field generated by one of the two devices 110, 160 set to terminal or reader mode to communicate with the other device 110, 160 in card emulation mode. The reverse is also possible. A same device can, particularly in the case of cell phones, operate in reader mode by generating a field intended for another device, or in card mode by capturing a field generated by another device.

During a transmission of information between one of devices 110, 160 in reader mode and the other device 110, 160 in card - or tag - emulation mode, the reader generates a magnetic field via its antenna, which is generally a sine wave at 13.56 MHz in conventionally used standards. An amplitude modulation can be used for the coding of the communication.

This NFC technology also enables an NFC device to charge one or more other NFC devices placed nearby.

In the present disclosure, two aspects are considered:
a first aspect in which at least one of NFC devices 110, 160 is compatible with the type-A technology only (according to the NFC Forum or the ISO standard 14443-3), and
a second aspect in which at least one of the two NFC devices 110, 160 is compatible with both type-A and B technologies.

In the example of FIG. 1, NFC 110 device comprises a matching circuit 130 (MATCHING CIRCUIT) coupling an antenna 120 (ANTENNA) to a demodulator circuit, otherwise called demodulator 132 (DEMOD) or decoder. The demodulator is, for example, a radio frequency decoder capable of transforming a received analog signal into another analog or digital signal ready for decoding. Demodulator 132 couples, for example, impedance matching circuit 130 to a control unit, otherwise called NFC controller 140 (NFC CONTROLLER). Demodulator 132 incorporates, for example, a type-A demodulator and/or a type-B demodulator. In an optional example, not shown, NFC device 110, 160 comprises a detector of type-A or B frames or other. This detector for example forms part of demodulator 132. Detector is for example coupled to demodulator 132 and/or to NFC controller 140.

Control unit or NFC controller 140 is for example assimilated to a processing unit containing for example a microprocessor further coupled to one or more memories 150 (MEM), which are for example volatile or non-volatile memories, via a communication bus 142. Memory 150 comprises, for example, registers for storing the configurations of NFC controller 140 or for storing, for example, information relative to NFC communication, such as for example data resulting from the radio frequency decoding. In an example, memory 150 is for example a volatile RAM-type memory. In another example, NFC controller 140 is configured to run one or more programs.

In an example, one of the two devices 110 or 160 has no power supply and is powered by the electromagnetic field of the other device set to reader mode (proximity coupling device, PCD).

One of NFC 110 devices or device 160 is, for example, a phone or a smartphone, or a terminal, emulated in reader mode.

This enables to exchange information between one of the NFC devices operating as a contactless reader and secure elements located in the other NFC device, for example. Many applications are thus possible, such as mobile ticketing for public transport (the cell phone being used as a transport ticket) or mobile payment (the cell phone being used as a payment card).

In an example, all blocks 130, 132, 140, 142, 150 are comprised in a microcontroller.

NFC communications are for example, are divided into a plurality of phases, a phase called IDLE, followed by a communication start phase, followed by a frame information phase and eventually an end-of-communication phase.

For example, in a proximity inductively-coupled card (PICC) mode, one of the two devices 110 or 160 operates as a proximity inductively-coupled card and enters an electromagnetic field generated by the other device set to reader (PCD) mode. When the electromagnetic field of the reader exceeds a given value, then the IDLE phase is carried out. The first frame expected after the IDLE phase is called short frame. It has a specific format comprising a start condition, seven bits, and an end condition. The start condition, also known as the start-of-frame (SoF) symbol, is characterized by a different signal shape depending on technology A or technology B.

The phase, or state, called IDLE, is a so-called inactive phase. In the IDLE state, the PICC device is powered by the electromagnetic field of the other NFC device. The PICC device listens for commands referred to as REQA and WUPA (respectively REQB, WUPB for type B) in standards. When these commands are validly received and a query response referred to as ATQA (respectively ATQB) has been sent to the other device, then a phase, or state, referred to as READY in standards is implemented.

In the READY phase, an anticollision bit is applied and a unique identifier UID is obtained. When the unique identifier is selected, an activation phase, or state, referred to as ACTIVE in standards, is implemented.

In the ACTIVE phase, the device in PICC mode can accept RATS protocol activation commands or proceed according to other methods.

After activation phase ACTIVE, another so-called protocol phase PROTOCOL is implemented, in which the device in PICC mode is powered by the electromagnetic waves of the other device, and a communication is established according to a communication protocol type defined by protocol type information data. In the PROTOCOL state or phase, the expected format of the received frames is a so-called standard format comprising at least one byte, parity bits, and a cyclic redundancy code encoded on two bytes.

Reference should be made to ISO standard 14443-3, for example, to have all the implementation details of these different phases or states.

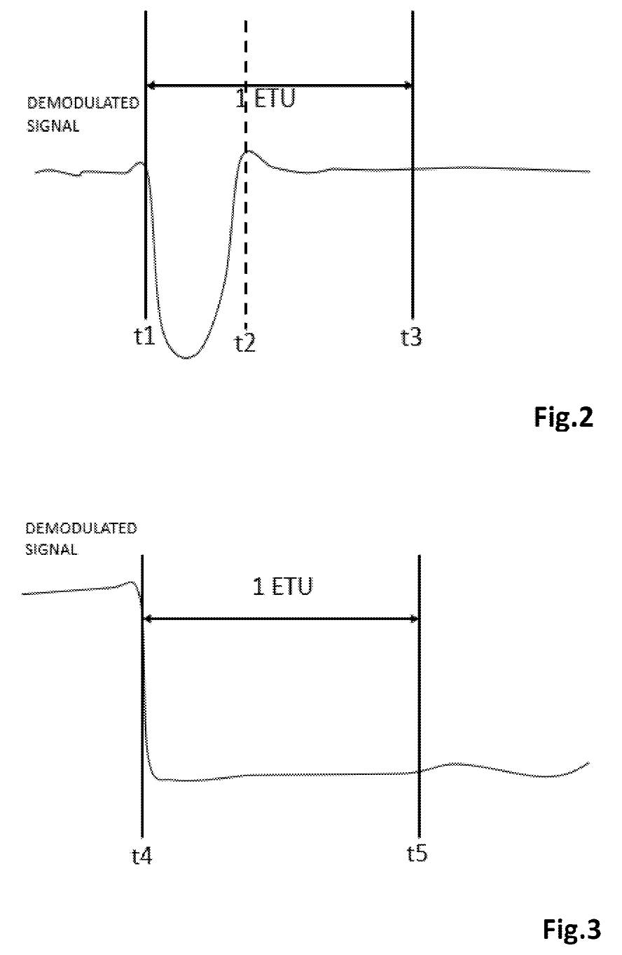

FIG. 2 shows a timing diagram of an example of operation of an NFC device of FIG. 1.

More particularly, FIG. 2 shows a start-of-frame symbol SoF, once the 13.56-MHz NFC signal has been demodulated (amplitude demodulation AM, DEMODULATED SIGNAL), and corresponding to the A technology.

In the example shown in FIG. 2, before a time t1, the signal is at a high level, then, at time t1, the signal level abruptly drops to a low level and remains there until a time t2. At time t2, the signal level returns to the high level and remains there until at least a time t3. The time period between t1 and t3 corresponds to a time period during which the shape of the SoF symbol is sought. This time period corresponds to an elementary time unit (ETU). In other words, considering the modulation of the base signal, the type-A start symbol corresponds to low-state modulation for less than 50% of the time of the elementary time unit. This duration is referred to as PauseA in ISO standard 14443-3.

FIG. 3 shows a timing diagram of an example of operation of an NFC device of FIG. 1.

More particularly, FIG. 3 shows a start symbol of the B technology, once the 13.56-MHz NFC signal has been demodulated (AM amplitude demodulation, DEMODULATED SIGNAL).

In the example shown in FIG. 3, before a time t4, the signal is at a high level, after which, at time t4, the signal level abruptly drops to a low level and remains there until at least a time t5. The period of time between times t4 and t5 corresponds to a time period during which the shape of the symbol is sought. This time period corresponds to an elementary time unit. In other words, considering the modulation of the base signal, the type B start symbol corresponds to a low-state modulation for 100% of the time of the elementary time unit.

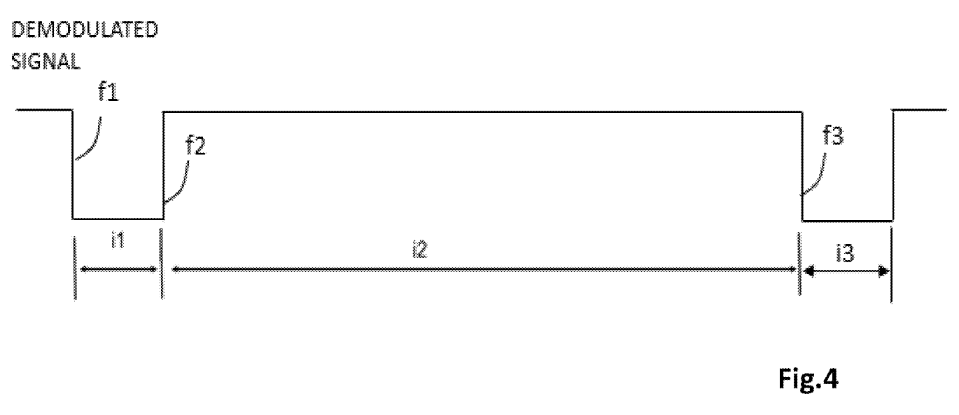

FIG. 4 shows an timing diagram of operation of an NFC device 110, 160 of FIG. 1.

More particularly, FIG. 4 shows a timing diagram of a base signal received by one of the two NFC devices 110, 160 in card emulation mode, once the 13.56-MHz NFC signal has been demodulated (AM amplitude demodulation, DEMODULATED SIGNAL). In the shown example, a first modulated portion (i1) represents a first symbol arriving first, and a second modulated portion (i3) represents a second symbol arriving successively after the first symbol.

In the shown example, a time period i1 corresponds to a period of time between a falling edge f1 arriving first and a rising edge f2 arriving just after the falling edge f1.

In the shown example, a time period i2 corresponds to a period of time between the rising edge f2 and a second falling edge f3 arriving after the rising edge f2. The falling edge f3 corresponds, for example, to the start of the successively-arrived modulated part of the second symbol.

The analysis of the timing diagram of FIG. 4 enables, for example, a decoder or demodulator 132 only analyzing falling edges f1 and f3 to recognize the type of the received frames.

However, there may happen, for example, that the type-B start symbol received by a demodulator only accepting the type-A technology and only detecting falling edges, comprises a glitch which causes the base signal to drop to a low level momentarily before rising again. This may make this demodulator, only accepting type-A technology and only detecting falling edges, believe that the received frame is of type A, whereas it is actually of type B. The reception of a start symbol takes place in a phase when NFC controller 140 is in standby mode, there thus is no action of the NFC controller and an inextricable blocking situation may then arise.

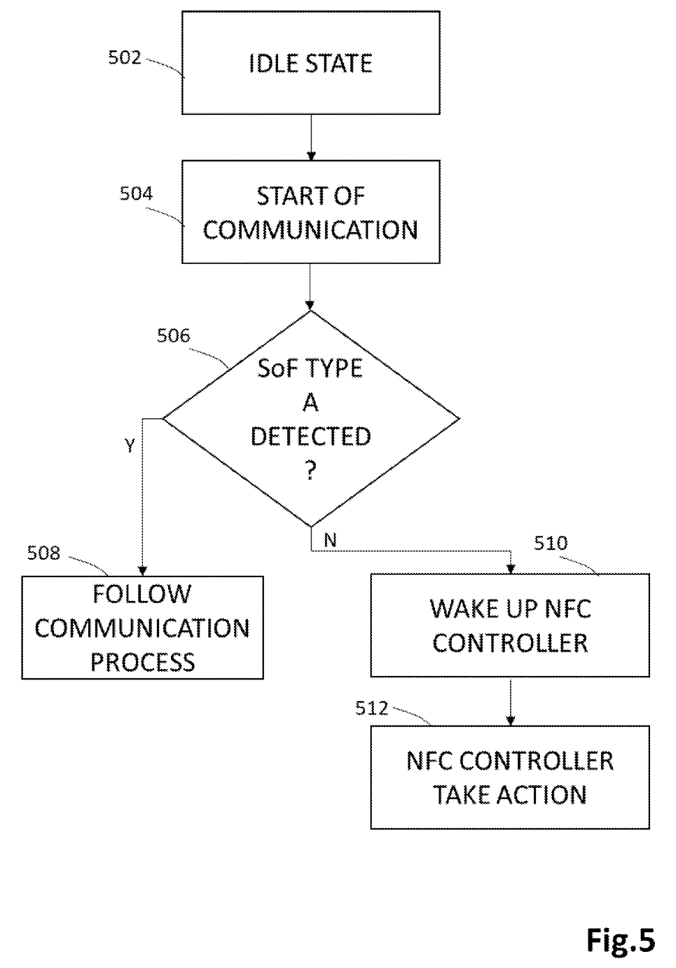

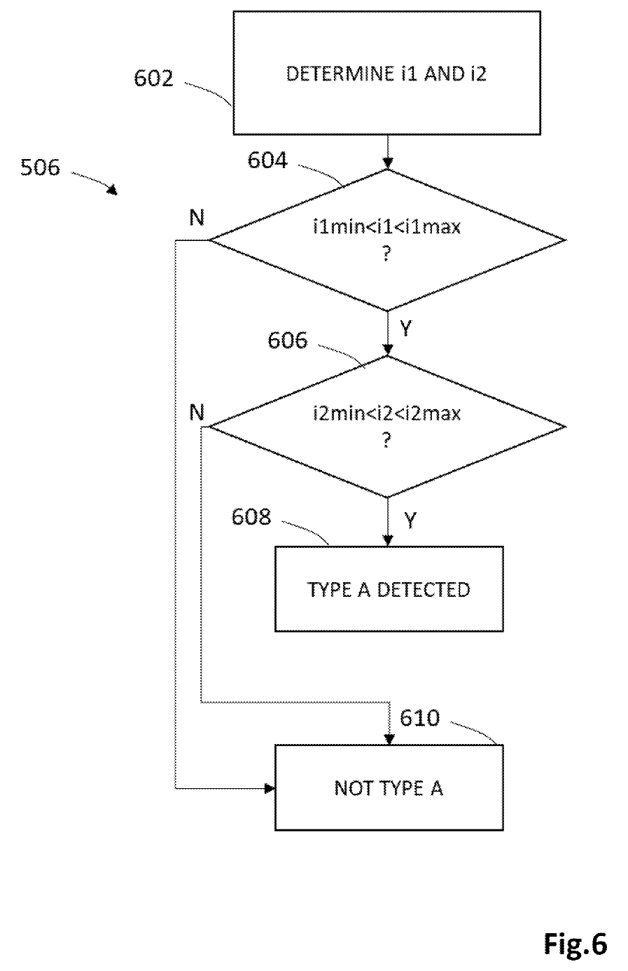

This issue is addressed by the first aspect illustrated in the examples of FIGS. 5 and 6.

The embodiments disclosed in relation with the first aspect thus provide a type-A NFC device comprising a type-A frame demodulator configured to cause a waking up of the control unit when at least one start of frame (SoF) is detected as not being of type A.

In other words, in the first aspect, the type-A NFC device comprises a type-A frame demodulator configured to cause a waking up of the NFC controller when at least one start-of-frame symbol (SoF) is detected as not being of type A.

The waking up of the NFC controller, in other words of the control unit, enables action to be taken to come out of a possible blocking situation.

Based on the recognition of the start-of-frame symbol, in other words start-of-frame symbol SoF, it is possible to react as quickly as possible as soon as the frames are received.

FIG. 5 shows a method of operation of an NFC device 110, 160 of FIG. 1 according to an embodiment of the first aspect. In this example, the NFC device is of type A only.

In a step 502 (IDLE STATE), NFC device 110, 160 is in the IDLE state.

In a step 504 (START OF COMMUNICATION), subsequent to step 502, NFC controller 140 is in standby mode. Decoder or demodulator 132 receives frames, for example, short.

In a step 506 (SoF TYPE A DETECTED?), demodulator 132 determines whether the start symbol is of type A. This determination consists in locating a start symbol, which is similar to that shown in FIG. 2.

In the case where the start symbol is of type A (Y branch), then step a 508 (FOLLOW COMMUNICATION PROCESS) is implemented.

In the case where the start symbol is not recognized as being of type A (branch N), then step 510 (WAKE UP NFC CONTROLLER) is implemented.

In step 508, the communication process continues without waking up the NFC controller, for example. The READY and ACTIVE phases or states are for example then implemented.

Step 510 consists, for example, in demodulator 132 causing the waking up of the NFC controller by modifying a state of a first signal. This first signal is applied, for example, to an error output. This error output is, for example, an error output of a cyclic redundancy code (CRC). The error output is, in another example, an error output of an error correction code (ECC).

The fact of changing a state of a signal on this type of error output enables to simulate an error, while it is neither a CRC-type error nor an ECC error. Here, the fact that a CRC-type or ECC error normally implies the waking up of the NFC controller is used to wake up the NFC controller. Indeed, ISO standard 14443 or the NFC Forum do not provide this kind of possibility of waking up.

In a step 512 (NFC CONTROLLER TAKE ACTION), subsequent to step 510, NFC controller 140 analyzes, for example, the start symbol and takes action to unlock the situation, for example, by ignoring or rejecting the frame received with the start symbol which is not of type A.

The robustness of the detection of the type-A start symbol can be improved to ensure almost certainly that, at step 506, the start symbol is effectively of type A or is not.

To achieve this, it would be possible, for example, to add another demodulator, this one only dedicated to type B. But this causes a higher cost, a higher energy consumption, and this complicates the operation of the NFC device.

FIG. 6 shows an embodiment of a step in the method of FIG. 5. More particularly, FIG. 6 provides a method of making the identification of the frame type robust by the identification of a type-A SoF start or beginning symbol during the step 506 of FIG. 5.

In a step 602 (DETERMINE i1 AND i2) of step 506, the time periods i1 and i2 shown in FIG. 4 are determined. In an example, this determination is carried out based on two successive frames.

In a step 604 (i1min<i1<i1max?) of step 506, subsequent to step 602, demodulator 132 verifies that time period i1 lies within a first time interval i1min, i1max. The first time interval is, for example, determined from the SoF start symbol characteristics defined in ISO standard 14443 or the NFC forum, to which respective time values are added or subtracted.

If time period i1 does not lie within the first time interval (branch N), then step 610 (NOT TYPE A) is implemented.

If time period i1 lies within the first time interval (Y branch), then a step 606 (i2min<i2<i2max?) is implemented during which demodulator 132 verifies that the second time period i2 lies within a second time interval i2min, i2max. The second time interval is determined, for example, from SoF start symbol characteristics defined in ISO standard 14443 or the NFC forum, to which respective time values are added or subtracted.

If the result of step 606 is positive (Y branch), then a step 608 (TYPE A DETECTED) is implemented, in which type A is considered as detected.

If the result of step 606 is negative (branch N), then step 610 (NOT TYPE A) is implemented. In this step, the received frame is considered as not being of type A.

The example of FIG. 6 enables to improve the robustness of detection of the SoF start symbol for type-A frames, which enables not to wake up the NFC controller too often.

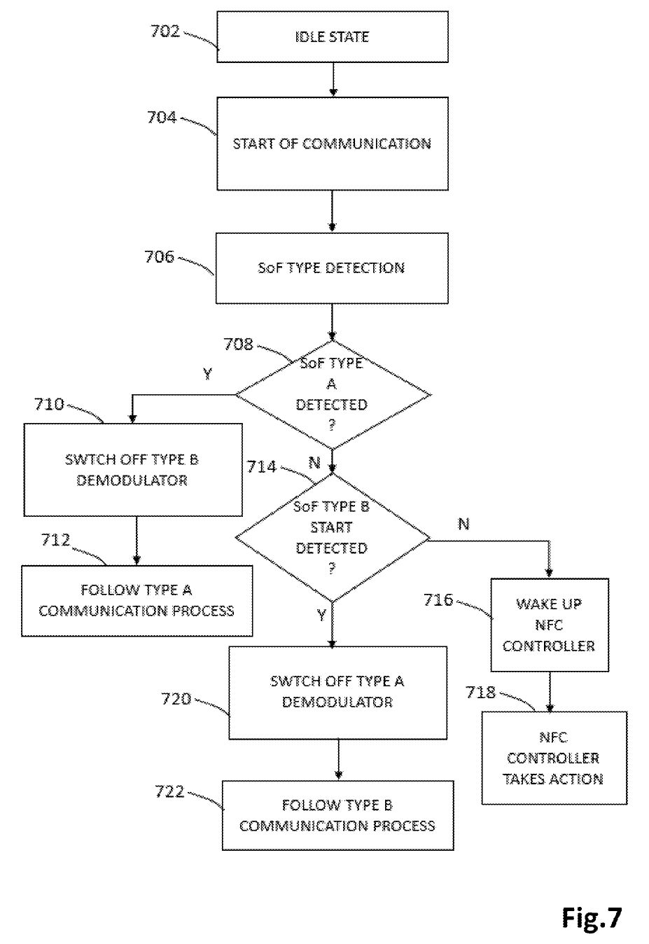

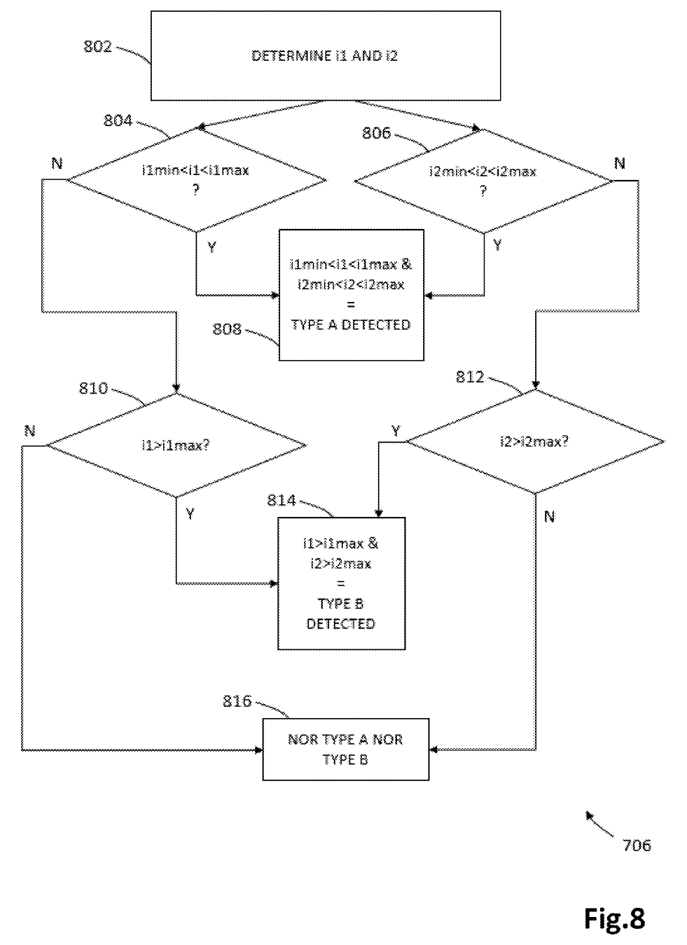

FIGS. 7 and 8 concern the second aspect.

The second aspect deals with the case where at least one of NFC devices 110, 160 should be capable of handling type-A and B technologies.

An issue of this second aspect is to be able to determine in a robust and reliable way the type of the received frames.

For this purpose, the embodiments described hereafter provide an NFC device of type A and B, comprising a first type-A frame demodulator, a second type-B frame demodulator, and a detector of the received frame type configured to:
determine a first time period (i1) of a start of frame (SoF), elapsing between a first falling edge arriving first, and a first rising edge arriving after the first falling edge;
determine a second time period (i2) of the start of frame (SoF), elapsing between the first rising edge arriving after the first falling edge, and a second falling edge arriving after the first rising edge; and
deduce, according to the values of the first and second calculated time periods (i1, i2), the type of frames received.

FIG. 7 shows a method of operation of an NFC device of FIG. 1 according to the second aspect.

In the shown example, in a step 702 (IDLE STATE) the NFC device is in card emulation mode and in the IDLE state.

In a step 704 (START OF COMMUNICATION), subsequent to step 702, the NFC controller, in other words control unit, 140 is in standby mode. The type-A and B decoders of demodulator 132 receive frames, for example, short.

In a step 706 (SoF TYPE DETECTION), subsequent to step 704 or concurrent therewith, the frame type detector (or demodulator 132) analyzes the frames received. This detection consists, for example, in determining the periods i1 and i2 of FIG. 4 to deduce the frame type therefrom.

In a step 708 (SoF TYPE A DETECTED?), subsequent to step 708, if the detected frame is of type A (Y branch) then a step 710 (SWTCH OFF TYPE B DEMODULATOR) is implemented.

In step 710, the type-B frame demodulator is set to standby. This enables to save energy. A step 712 (FOLLOW TYPE A COMMUNICATION PROCESS) is then implemented, during which the communication process continues with type A. In step 712, the READY, ACTIVE, and PROTOCOL states may follow one another.

In step 708 (SoF TYPE A DETECTED?), if the detected frame is not detected as being of type A (branch N), then a step 714 (SoF TYPE B START DETECTED?) is implemented.

In step 714, if the detected frame is of type B (Y branch) then a step 720 (SWTCH OFF TYPE A DEMODULATOR) is implemented. If the detected frame is not considered as being of type B (branch N), then a step 716 (WAKE UP NFC CONTROLLER) is implemented.

In step 716, the NFC controller is for example woken up, if it was previously off, so as to implement a step 718 (NFC CONTROLLER TAKES ACTION) during which it takes countermeasures, for example, after analysis of the received frames. In another example, in step 718, the frames are rejected or no action is taken by the NFC controller.

In step 720, the type-A frame demodulator is set to standby. This enables to save energy. A step 722 (FOLLOW TYPE B COMMUNICATION PROCESS) is then implemented, during which the communication process continues with type B. In step 722, the READY, ACTIVE, and PROTOCOL states may follow one another.

FIG. 8 shows an embodiment of a step of the method of FIG. 7. More particularly, FIG. 8 describes an embodiment of step 706.

In a step 802 (DETERMINE i1 AND i2) of step 706, time periods i1 and i2 are determined, either by one or more decoder/demodulators 132 or by the detector, for example.

In a step 804 (i1min<i1<i1max?) of step 706, subsequent to step 802, the decoder(s)/demodulator(s) 132 or the detector verify that time period i1 lies within a first time interval i1min, i1max. The first time interval is determined, for example, from the SoF start symbol characteristics defined in ISO standard 14443 or the NFC forum, to which respective time values are added or subtracted.

In a step 806 (i2min<i2<i2max?) of step 706, taking place at the same time as or offset in time from step 804, the decoder(s)/demodulator(s) 132 or detector verifies that second time period i2 lies within a second time interval i2min, i2max. The second time interval is determined, for example, from SoF start symbol characteristics defined in ISO standard 14443 or the NFC forum, to which respective time values are added or subtracted.

If i1 lies within the first time interval and i2 lies also within the second time interval (Y branches of steps 804 and 806), then a step 808 (i1min<i1<i1max & i2min<i2<i2max = TYPE A DETECTED) is implemented, during which the frame is considered as being of type A.

In the case where i1 does not lie within the first time interval (branch N of step 804), a step 810 (i1>i1max?) is implemented.

In step 810, the decoder(s)/demodulator(s) 132 or the detector compares i1 with the upper limit i1max of the first interval. If i1 is smaller than i1max (Y branch) (N branch), this means that i1 is smaller than the lower limit i1min of the first interval, and a step 816 (NO TYPE A NO TYPE B) is implemented.

In the case where i2 is not within the second time interval (branch N of step 806), a step 812 (i2>i2max?) is implemented. In step 812, the decoder(s)/demodulator(s) 132 or the detector compares i2 with the upper limit i2max of the second interval. If i2 is greater than i2max (Y branch) and i1 is greater than i1max (Y branch of step 810), then step 814 (i1>i1max & i2>i2max = TYPE B DETECTED) is implemented.

If, in step 812, i2 is smaller than i2max (branch N), this means that i2 is smaller than the lower limit i2min of the second interval and step 816 (NOR TYPE A NOR TYPE B) is implemented.

In step 816, the received frame is considered as being neither of type A nor of type B.

The example of FIG. 8 allows a robust and fast detection of the type of frame, since it is based on the analysis of the beginning or start symbol. The fact of using successive falling edges f1, f3 and the intercalary rising edge f2 enables to be more precise than methods using falling edges only. The fact of using falling edge f3, which is part of a second successive frame, thus enables to gain detection accuracy and not to interpret an erroneous type-B frame as being a type-A frame.

The following examples of embodiment relate to the second aspect.

Example 1: Type-A and B NFC device, comprising a first type-A frame demodulator, a second type-B frame demodulator, and a detector of the type of frame received configured to:
determine a first time period (i1) of a start of frame (SoF), elapsing between a first falling edge arriving first, and a first rising edge arriving after the first falling edge;
determine a second time period (i2) of the start of frame (SoF), elapsing between the first rising edge arriving after the first falling edge, and a second falling edge arriving after the first rising edge; and
deduce, as a function of the values of the first and second calculated time periods (i1, i2), the type of frames received.

Example 2: Method of operation of an NFC device of type A and B, comprising a first type-A frame demodulator, a second type-B frame demodulator, and a detector of the type of frame received, the method comprising:
determining, with the detector, a first time period (i1) of a start of frame (SoF), elapsing between a first falling edge arriving first, and a first rising edge arriving after the first falling edge;
determine, with the detector, a second time period (i2) of the start of frame (SoF), elapsing between the first rising edge arriving after the first falling edge and a second falling edge arriving after the first rising edge; and
deduce, with the detector, as a function of the values of the first and second calculated time periods (i1, i2), the type of frames received.

Example 3: Device according to example 1 or method according to example 2, in which the detector compares the first time period (i1) with a first time interval (i1min, i1max) and the second time period (i2) with a second time interval (i2min, i2max).

Example 4: Device or method according to the previous example, in which the first and second time intervals (i1min, i1max; i2min, i2max) are determined from frame symbol characteristics defined in ISO standard 14443 or the NFC forum, to which respective time values are added or subtracted.

Example 5: Device or method according to example 3 or 4, wherein if the first time period (i1) is within the first time interval, and if the second time period (i2) is within the second time interval, then the received frames are considered as being of type A.

Example 6: Device or method according to any of examples 3 to 5, wherein if the first time period (i1) is greater than a maximum limiting value of the first time interval and if the second time period (i2) is greater than a maximum limiting value of the second time interval, then the received frames are considered as being of type B.

Example 7: Device or method according to example 5 or 6, in which, if the received frames are considered as being of type A, then the second demodulator is deactivated.

Example 8: Device or method according to example 6 or 7, in which, if the received frames are considered as being of type B, then the second demodulator is deactivated.

Example 9: Device or method according to example 7 or 8, in which the detector is configured to wake up a control unit (CPU) when one of types A or B is detected.

Example 10: Device or method according to any of examples 3 to 9, wherein if the first time period (i1) is smaller than a minimum limiting value of the first time interval or if the second time period (i2) is smaller than a minimum limiting value of the second time interval, then the received frames are considered as being different from type A or type B.

Example 11: Device or method according to example 10 as dependent on example 9, in which the detector is configured to change a state of a first signal so as to cause a waking up of the control unit when the received frames are considered as being different from type A or type B.

Example 12: Device or method according to example 10 as dependent on example 9, in which the detector is configured not to wake up the control unit if the received frames are considered as being different from type A or type B.

Various embodiments and variants have been described. The person skilled in the art will understand that certain features of these various embodiments and variants could be combined, and other variants will become apparent to the person skilled in the art. In particular, in the example of FIG. 6, steps 604 and 606 can be interchanged so that if the first and second time periods do not respectively lie within the first and second time intervals, then the start-of-frame symbol SoF is not of type A.

Finally, the practical implementation of the described embodiments and variants is within the reach of the person skilled in the art on the basis of the functional indications given above. In particular, with regard to the example of FIG. 5 which has been described with respect to the detection of frames which are not of type A, those skilled in the art may use the same reasoning in the case of an NFC device compatible only with type B. In this case, step 506 of FIG. 5 will comprise verifying whether the SoF start symbol is of type B. It will also be possible for those skilled in the art to adapt the algorithm of FIG. 6 to the detection of the type-B start-of-frame symbol.

1. A type-A NFC device, comprising a type-A frame demodulator configured to cause a waking up of a control unit when at least one start of frame is detected as not being of type A.

2. The type-A NFC device according to claim 1, wherein, to cause the waking up of the control unit, the type-A frame demodulator modifies a state of a first signal.

3. The type-A NFC device according to claim 2, wherein the first signal is applied to an error output.

4. The type-A NFC device according to claim 3, wherein the error output is a cyclic redundancy code error output.

5. The type-A NFC device according to claim 3, wherein the error output is an error output of an error correction code.

6. The type-A NFC device according to claim 1, wherein the type-A frame demodulator is configured to reject, or not process, the frame having had its start of frame detected as not being of type A.

7. The type-A NFC device according to claim 1, wherein an interrupt is generated after the waking up of the control unit.

8. The type-A NFC device according to claim 7, wherein, after the interrupt, the control unit analyzes a content of the frame having had its start of frame detected as not being of type A and performs an action.

9. The type-A NFC device according to claim 1, wherein the type-A frame demodulator is configured to analyze at least two consecutive symbols to detect that a start-of-frame symbol is not of type A.

10. The type-A NFC device according to claim 9, wherein the type-A frame demodulator is configured to determine a first time period of a start-of-frame elapsing between a first falling edge arriving first and a first rising edge arriving after the first falling edge.

11. The type-A NFC device according to claim 10, wherein the type-A frame demodulator is configured to determine a second time period of the start of frame elapsing between the first rising edge arriving after the first falling edge, and a second falling edge arriving after the first rising edge.

12. The type-A NFC device according to claim 11, wherein the first time period corresponds to a first modulated portion and the second falling edge corresponds to the start of a second modulated portion arriving second after the first modulated portion.

13. The type-A NFC device according to claim 12, wherein the type-A frame demodulator is configured to verify the following conditions:
the first time period lies within a first time interval; and
the second time period lies within a second time interval;
if one of these conditions is not met, then the start of frame is considered as not being of type A.

14. The type-A NFC device according to claim 13, wherein the first time interval and the second time interval are determined from start-of-frame characteristics defined in standard ISO 14443 or an NFC forum, to which respective time values are added or subtracted.

15. A method of operation of a type-A NFC device comprising a type-A frame demodulator, the method of operation comprising:
waking up, by demodulator, of a control unit when at least one start of frame is detected as not being of type A.

16. The method of operation of the type-A NFC device according to claim 15, wherein waking up of the control unit is caused by the demodulator modifying a state of a first signal.

17. The method of operation of the type-A NFC device according to claim 16, wherein the first signal is applied to an error output.

18. The method of operation of the type-A NFC device according to claim 17, wherein the error output is a cyclic redundancy code error output.

19. The method of operation of the type-A NFC device according to claim 17, wherein the error output is an error output of an error correction code.

20. The method of operation of the type-A NFC device according to claim 15, wherein the demodulator is configured to reject, or not process, the frame having had its start of frame detected as not being of type A.
